(19) United States
(12) Patent Application Publication
(10) Pub. No.: US 2020/0030725 A1
(43) Pub. Date: Jan. 30, 2020

(54) HOUSEHOLD REFRIGERATION APPARATUS HAVING WATER FILTER WITH A FILTER HEAD, AT WHICH AN ELECTRICALLY SWITCHED VALVE IS DIRECTLY ARRANGED

(71) Applicant: BSH HAUSGERAETE GMBH, Muenchen (DE)

(72) Inventors: KARL-FRIEDRICH LAIBLE, LANGENAU (DE); EUGEN GAPLIKOW, BUBESHEIM (DE)

(21) Appl. No.: 16/047,268

(22) Filed: Jul. 27, 2018

(51) Int. Cl. B01D 35/02; B01D 35/157; C02F 1/00; F25D 23/12

(52) U.S. Cl. CPC B01D 35/02; B01D 35/1573; C02F 1/003; F25D 23/126; F25D 2323/121; C02F 2307/12; C02F 2201/006; C02F 2201/005; B01D 2201/302

(57) ABSTRACT

A household refrigeration apparatus (1) has a housing (2) with a receiving space (7) for food and a water line system (18). The water line system includes a line device (19) and at least one water filter (21). The water filter (21) has a filter head (22), and the water line system (18) includes at least one electrically switched water valve (25). The electrically switched water valve (25) is directly arranged at the filter head (22). At least one water consumer (17) is connected to the water line system (18).

### TECHNICAL FIELD

An aspect of the invention relates to a household refrigeration apparatus with a housing and with a receiving space for food. The household refrigeration apparatus comprises a water line system. The water line system comprises a line device and comprises at least one water filter.

### BACKGROUND OF THE INVENTION

It is known that household refrigeration apparatuses can be formed with a dispenser unit for dispensing liquid and/or ice form elements. Such a dispenser unit has to be connected to a water system to allow the supply of liquid such that the ice form elements to be produced can be formed from this liquid. The production of drinks, which can then be dispensed via the dispenser unit, optionally requires water, which has to be externally supplied. In this context, it is known that a household refrigeration apparatus comprises a water line system in which is arranged a water filter, by which the externally supplied water is filtered, and a switching valve, by which the external supplied water is blocked or unblocked. However, such a water filter and water valve configuration requires corresponding space in the household refrigeration apparatus.

### SUMMARY OF THE INVENTION

It is an object of the present invention to provide a household refrigeration apparatus, in which a water line system of the household refrigeration apparatus is formed in improved manner with respect to a possible leakage in connection areas.

This object is solved by a household refrigeration apparatus according to claim 1.

An aspect of the invention relates to a household refrigeration apparatus, which comprises a housing with a receiving space for food. Moreover, the household refrigeration apparatus comprises a water line system. Furthermore, it is provided that this water line system comprises a line device and comprises at least one water filter. The water filter comprises a filter head. The water line system comprises at least one electrically switchable or switched water valve, wherein this electrically switched water valve is directly arranged at the filter head. The household refrigeration apparatus moreover comprises at least one water consumer, which is connected to the water line system. By such a configuration of a household refrigeration apparatus, short paths are achieved especially at the location between the water valve and the filter head in that these two components are directly connected to each other. Laying additional hoses or lines, which would be arranged between the water valve and the filter head, can thereby be avoided. In particular, leakage problems, which occur by such additional line connections can thereby be avoided. By the particularly advantageous design with the electrically switched water valve, adequately unblocking or blocking the water supply to the water filter can be fast and precisely effected. Thereby, a valve, namely the water valve, which allows blocking or unblocking the relevant flow path for the delivery of water to the filter, is directly arranged at the filter head itself. If the filter head is coupled to a cartridge of the water filter, blocking or unblocking a flow path through the cartridge can be effected by electrically switching the water valve. Moreover, a very individual and accurate actuation by a corresponding electrical switching signal can be effected by the electrically switched water valve. Wear of mechanical actuating elements can thereby be avoided and thereby too blocking and unblocking can be effected to the effect that leakages in the valve area itself can be avoided.

Only partially shutting off the flow path to the water filter can thereby be avoided such that water either does not arrive at the water filter, in particular at the cartridge, in the blocked state even if the cartridge is connected to the filter head.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not comprise all of the features of an originally formulated independent claim. Moreover, implementations and feature combinations are to be considered as disclosed, in particular by the implementations set out above, which extend beyond or deviate from the feature combinations set out in the relations of the claims.

### BRIEF DESCRIPTION OF THE DRAWINGS

Below, embodiments of the invention are explained in more detail based on schematic drawings. There show:

FIG. 1 a simplified longitudinal section representation through an embodiment of a household refrigeration apparatus according to the invention;

FIG. 2 a perspective representation of a water filter with an electrically switchable water valve directly arranged thereat; and

FIG. 3 a sectional representation through the assembly according to FIG. 2.

### DETAILED DESCRIPTION OF PREFERRED EMBODIMENTS

In the figures, identical or functionally identical elements are provided with the same reference characters.

With indications of “top”, “bottom”, “front”, “rear”, “horizontal”, “vertical”, “depth direction”, “width direction”, “height direction”, etc., the positions and orientations given in intended use and intended arrangement of the apparatus are specified.

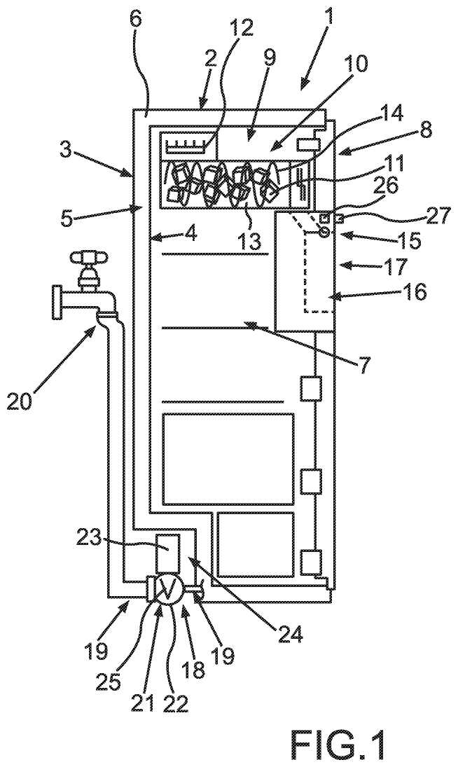

In FIG. 1, a household refrigeration apparatus 1 is shown in a schematic vertical section representation, which is in particular formed for storing and preserving food.

The household refrigeration apparatus 1 can be a refrigerator or a freezer or a fridge-freezer. The household refrigeration apparatus 1 comprises a housing 2. The housing 2 comprises an exterior housing 3, in which an interior container 4, which is formed separately from the exterior housing 3, is arranged. In a clearance 5 between the exterior housing 3 and the interior container 4, a thermally insulating material 6 is introduced, for example an insulating foam. Additionally thereto or instead thereof, a vacuum insulation panel can for example similarly be arranged therein.

The interior container 4 bounds at least one receiving space 7 for food with its walls, which can be a refrigerating compartment or a freezing compartment. In the shown embodiment, it is in particular provided that the receiving space 7 is a refrigerating compartment.

Furthermore, the household refrigeration apparatus 1 comprises a door 8, which is pivotably arranged at the housing 2. The receiving space 7 is closeable on the front side by the door 8.

Moreover, the household refrigeration apparatus 1 comprises a further receiving space 9. An ice maker 10 is arranged in this receiving space 9. Ice form elements 11 can be produced by this ice maker 10. Thereto, the ice maker 10 comprises at least one ice tray 12, in which water can be filled into individual form areas and which water is then frozen. In particular, temperatures are adjusted in the further receiving space 9, which allow such freezing of the water. The thus then produced ice form elements are removed from the ice tray 12 and taken into a collecting container 13 of the ice maker 10. There, they can be brought to a output unit 15 via a conveying unit 14. The ice form elements can be introduced into a provided vessel such as for example a drinking glass via the output unit 15. The output unit 15 preferably comprises an open placement recess 16 on the front side, into which the vessel can be placed. This placement recess 16 is accessible exposed towards the front. The output unit 15 is in particular arranged in the door 8. Moreover, additionally thereto or instead thereof, the output unit 15 is also formed to dispense liquids. In particular, drinks or else cooled water can here be dispensed.

Further, the ice maker 10 and the output unit 15 are constituents of a dispenser unit 17 of the household refrigeration apparatus 1. The dispenser unit 17 is an example for a water consumer, which is a device of said household refrigeration apparatus 1.

Moreover, the household refrigeration apparatus 1 comprises a water line system 18. The water line system 18 comprises a line device 19. The household refrigeration apparatus 1 is in particular connected to a water connection 20 external to apparatus, in particular a home water network, by this line device 19. Thereby, water can be externally delivered to the household refrigeration apparatus 1. This water is then also delivered to the ice maker 10 by the line device 19 to either produce the ice form elements 10 or to cool the delivered water by the ice maker 10 or another unit of the dispenser unit 17 and to then dispense it alone or in connection with additives via the output unit 15.

This water line system 18 of the household refrigeration apparatus 1 in particular comprises at least one water filter 21. The water filter 21 comprises a filter head 22 and a filter cartridge 23. It can be provided that the water filter 21 is arranged in a machine room 24 of the household refrigeration apparatus 1. The machine room 24 is in particular formed in the lower, rear area of the household refrigeration apparatus 1. Further components of a refrigeration circuit of the household refrigeration apparatus 1 can also be arranged in this machine room 24, such as for example a compressor.

The water filter 21 is installed in the line device 19. The water inflowing from the external water connection 20 is thus passed through the water filter 21 and thus arrives in particular at the ice maker 10 and/or at another unit of the household refrigeration apparatus 1, in particular at a storage area for water of the dispenser unit 17, in filtered manner.

Further, it is provided that the water line system 18 is constructed such that water can arrive at the ice maker 10 and/or at another unit of the dispenser unit 17 only and exclusively through a water filter 21. Thus, only filtered water always arrives at these mentioned units. A household refrigeration apparatus 1 is provided, which does not comprise a bypass line to the water filter 21. A bypass of the water filter 21 to conduct externally supplied water to the mentioned units in unfiltered manner, is therefore not provided.

Further, the water filter 21 comprises a water valve 25. The water valve 25 is an electrically switched valve. In particular, it is provided that the household refrigeration apparatus 1 comprises a control unit 26, which is only symbolically drawn in FIG. 1 and which is not to be conclusively understood in its position at all, but can also be diversely otherwise installed in the household refrigeration apparatus 1. By means of this control unit 26, the electrically switched water valve 25 can be controlled by a corresponding trigger signal or control signal. For example, such a control signal can be generated by actuating an operating element 27 via the control unit 26. Thus, switching of the water valve 25 is for example performed if a user requests a dispense of ice form elements and/or water via the dispensing unit 15 via the operating element 27. Here, the water valve 25 is thus in particular provided to unblock or block a water circuit, in particular depending on an actuating operation or a requested dispensing operation. Blocking or unblocking an inflow of water to the water filter 21 is effected by the electrically switched water valve 25 if the filter head 22 is arranged at the filter cartridge.

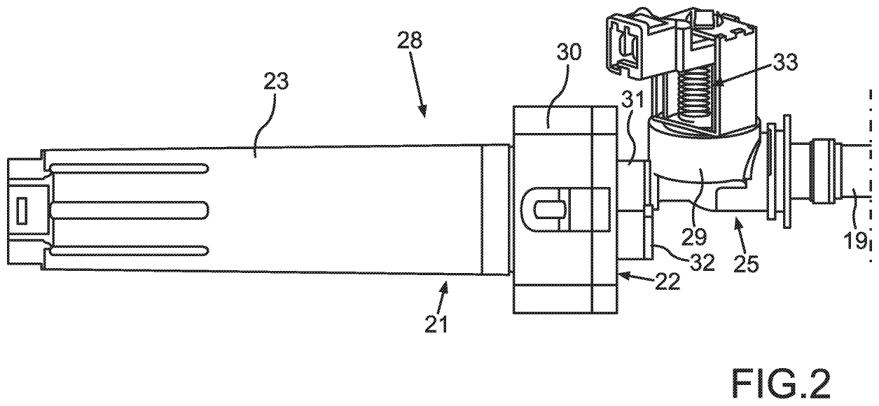

In FIG. 2, a module 28 is shown in a perspective representation, which shows the water filter 21 and the water valve 25. As is here apparent, the water valve 25 with a valve housing 29 is directly arranged at the filter head 22. Here, an integral configuration of the valve housing 29 with a housing 30 of the filter head 22 is in particular provided. Here, an integral component, for example of plastic, can in particular be formed. This integral component can in particular be manufactured as an injection molding component.

In a further implementation, it is provided that the filter head 22 comprises an inlet 31 and an outlet 32. Here, these inlets 31 and 32 in particular respectively formed as nozzles are preferably arranged in parallel. In particular, the valve housing 29 is directly arranged at one of these nozzles, for example at the inlet 31 or at the outlet 32. The water is supplied into the water filter 21 via the inlet 31 and then again discharged via the outlet 32 in the filtered state.

Alternatively to an integral configuration of the valve housing 29 with the housing 30, a non-destructively non-detachable connection, such as for example an adhesive connection, between the valve housing 29 and the housing 30 can also be provided.

Similarly, a non-destructively detachable connection such as a screw connection or the like can for example be provided. However, the integral configuration is particularly advantageous since interfaces, across which a leakage can occur, are thereby particularly advantageously avoided.

Further, a solenoid 33 can be arranged in the valve housing 29.

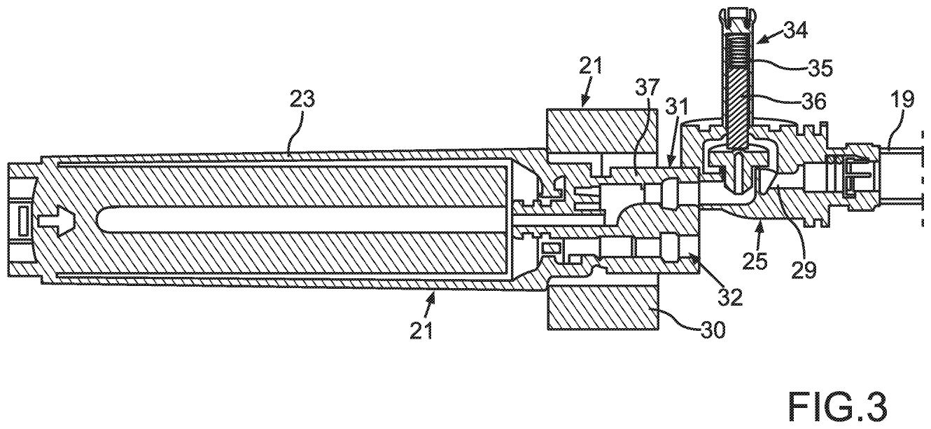

In FIG. 3, the arrangement of the module 28 is shown in a sectional representation. The water valve 25 comprises a valve nozzle 34, which is arranged in the area of the solenoid 33. In FIG. 3, this solenoid 33 is not illustrated. A spring 35 is arranged at this valve nozzle 34 and a movable plunger 36 is moreover arranged. Depending on the electrical control signal, a flow path for water through the water valve 25 is unblocked or blocked. In particular, this is effected by the plunger 36, which can in particular also be a lifting solenoid.

In a further implementation, it is provided that the ice maker 10 or the dispenser unit 17 represents an example for a water consumer of the household refrigeration apparatus 1.

In a further implementation, it can be provided that the water filter 21 comprises a blocking valve 37, which is preferably arranged in the filter head 22. The blocking valve 37 is a valve separate to the water valve 25 in an embodiment. A water conducting connection between the filter head 22 and the filter cartridge 23 can be blocked by the blocking valve 37 if the filter cartridge 23 is decoupled from the filter head 22.

In an alternative implementation, it can be provided that the water valve 25 takes over the function of the blocking valve 37 at the same time and thus the blocking valve 37 can be saved. In the shown implementation, in case of a blocking valve 37 present separately to the water valve 25, it can be provided that this blocking valve 37 is arranged in the housing 30 of the filter head 22.

In addition to the integral housing 30, which can preferably be integrally formed with the valve housing 29, the filter head 22 can comprise components separate thereto. For example, this can be a main support part or additional parts. The blocking valve 37 can also be such a separate component. Sealing elements in the housing 30 can also be regarded as such separate components.

It can also be provided that a first water valve 25 is directly connected to the outlet 31 of the housing 30, in particular formed integrally therewith. It can also be provided that a further water valve 25 with an own valve housing 29 is additionally directly connected to the outlet 32 of the housing 30, in particular formed integrally therewith. In such a configuration, two separate water valves 25 are then directly arranged at the filter head 22. In particular, in direct arrangements of the valve housing 29 at the housing 30, a line-like intermediate element is not arranged at all between these mentioned housings.

Generally, it is provided that the household refrigeration apparatus comprises a water connection in an advantageous implementation, via which water can be supplied from a water network external to apparatus to the household refrigeration apparatus. Preferably, it is provided that the water valve comprises a valve housing, which is directly arranged at a housing of the filter head. In particular, this direct arrangement is formed without an intermediate line. It can be provided that the valve housing and the housing of the filter head are formed as one piece, in particular are produced in one production process. The integral piece can then be made of plastic and for example be an injection molding component.

In an alternative implementation, it can be provided that the valve housing is directly arranged at the housing of the filter head by a non-destructively detachable connection. For example, a non-destructively detachable connection can be a screw connection or a locking connection.

In an alternative implementation, it can be provided that the valve housing is arranged at the housing of the filter head by a non-destructively non-detachable connection. A non-destructively non-detachable connection can for example be an adhesive connection.

Further, the water line system is formed such that water, which is guided to the water consumer of the household refrigeration apparatus, is always passed through the water filter such that the water consumer always obtains filtered water.

Further, the water line system is formed without a bypass line for bypassing the water filter in delivering water to the water consumer.

Further, it is provided that the household refrigeration apparatus comprises an activating unit for generating an electrical signal for switching the electrically switched water valve. For example, the activating unit can comprise an operating unit, by which dispense of ice form elements or water by a output unit of the water consumer is requested upon actuation, and the electrical signal is generated by actuating this operating unit. Such an operating unit can for example be an operating element. As a further example, the activating unit can be associated with an ice maker, and the electrical signal is generated by the activating unit when the production of ice form elements is requested by the ice maker.

The valve housing of the water valve can be directly arranged at an inlet or an outlet of the housing of the filter head in an advantageous implementation.

The water valve can comprise a plunger, in particular a lifting solenoid, which is arranged in the valve housing and is variable in a position in the valve housing by an electrical signal such that a blocking state of the water valve or an unblocking state of the water valve is adjusted depending on the position of the lifting solenoid.

Further, it is provided that a blocking valve separate to the water valve is arranged in the filter head, by which a water conducting connection to a filter cartridge of the water filter separable from the filter head is separated if the filter cartridge is decoupled from the filter head. It can also be provided that the water valve and the blocking valve are formed by a single valve.

### LIST OF REFERENCE SIGNS

1 Household refrigeration apparatus

2 housing

3 exterior housing

4 interior container

5 clearance

6 thermally insulating material

7 receiving space

8 door

9 receiving space

10 ice maker

11 ice form elements

12 ice tray

13 collecting container

14 conveying unit

15 output unit

16 placement recess

17 dispenser unit

18 water line system

19 line device

20 water connection

21 water filter

22 filter head

23 filter cartridge

24 machine room

25 water valve

26 control unit

27 operating element

28 module

29 valve housing

30 housing

31 inlet

32 outlet

33 solenoid

34 valve nozzle

35 spring

36 plunger

37 blocking valve

1. A household refrigeration apparatus, comprising
a housing formed with a receiving space for food,
a water line system, which includes a line device, and at least one water filter, wherein the water filter includes a filter head having an inlet, and
the water line system includes at least one electrically switched water valve having a valve housing disposed directly at the inlet of the filter head, and the electrically switched water valve is directly arranged at the filter head, and
at least one water consumer connected to the water line system.

2. The household refrigeration apparatus according to claim 1, wherein the household refrigeration apparatus comprises a water connection, via which water can be supplied from a water network external to the household refrigeration apparatus to the household refrigeration apparatus.

3. The household refrigeration apparatus according to claim 1, wherein the valve housing is directly arranged at a housing of the filter head.

4. The household refrigeration apparatus according to claim 3, wherein the valve housing and the housing of the filter head are formed as one piece.

5. The household refrigeration apparatus according to claim 4, wherein said valve housing and the housing of the filter head formed as one piece is made of plastic.

6. The household refrigeration apparatus according to claim 3, wherein the valve housing is directly arranged at the housing of the filter head by a non-destructively detachable connection.

7. The household refrigeration apparatus according to claim 6, wherein the non-destructively detachable connection is a screw connection or a locking connection.

8. The household refrigeration apparatus according to claim 3, wherein the valve housing is arranged at the housing of the filter head by a non-destructively non-detachable connection.

9. The household refrigeration apparatus according to claim 8, wherein the non-destructively detachable connection is an adhesive connection.

10. The household refrigeration apparatus according to claim 1, wherein the water line system is formed such that water, which is supplied to the water consumer, is always passed through the water filter, such that the water consumer always obtains filtered water.

11. The household refrigeration apparatus according to claim 1, wherein the water line system is formed without a bypass line for bypassing the water filter upon delivering water to the water consumer.

12. The household refrigeration apparatus according to claim 1, wherein the household refrigeration apparatus comprises an activating unit for generating an electrical signal for switching the electrically switched water valve.

13. The household refrigeration apparatus according to claim 12, wherein the activating unit comprises an operating unit, by which dispense of ice form elements or water by a output unit of the water consumer is requested upon actuation, and the electrical signal is generated by the actuation.

14. The household refrigeration apparatus according to claim 12, wherein the activating unit is associated with an ice maker, and the electrical signal is generated by the activating unit when the production of ice form elements is requested by the ice maker.

15. (canceled)

16. The household refrigeration apparatus according to claim 1, wherein the water valve comprises a lifting solenoid, which is arranged in the valve housing and is variable in its position in the valve housing by an electrical signal such that a blocking state of the water valve or an unblocking state of the water valve is adjusted depending on the position of the lifting solenoid.

17. The household refrigeration apparatus according to claim 1, wherein a blocking valve separate to the water valve is arranged in the filter head, wherein with said blocking valve a water conducting connection to a filter cartridge of the water filter separable from the filter head is separated if the filter cartridge is decoupled from the filter head.
